(19) United States
(12) Patent Application Publication
(10) Pub. No.: US 2015/0371779 A1
(43) Pub. Date: Dec. 24, 2015

(54) MULTI-LAYERED CAPACITOR AND MANUFACTURING METHOD FOR THE SAME

(71) Applicant: SAMSUNG ELECTRO-MECHANICS CO., LTD., Suwon-Si (KR)

(72) Inventors: Jong-Bong LIM, Suwon-Si (KR); Hai-Joon LEE, Suwon-Si (KR); Doo-Young KIM, Suwon-Si (KR); Chang-Hoon KIM, Suwon-Si (KR)

(21) Appl. No.: 14/667,207

(22) Filed: Mar. 24, 2015

(30) Foreign Application Priority Data
Jun. 24, 2014 (KR) 10-2014-0077631

(51) Int. Cl. H01G 4/30; H01G 4/12; H01G 4/012

(52) U.S. Cl. CPC H01G 4/30; H01G 4/012; H01G 4/12

(57) ABSTRACT

A multi-layered capacitor and a method of manufacturing the same are disclosed. The multi-layered capacitor in accordance with an aspect of the present invention includes: a laminate structure having a plurality of unit structures laminated therein, the plurality of unit structures each including a substrate, a lower electrode film formed over the substrate, a dielectric film formed over the lower electrode film and an upper electrode film formed over the dielectric film; a first external electrode formed on one surface of the laminate structure and configured to be electrically connected with the lower electrode film; and a second external electrode formed on the other surface of the laminate structure and configured to be electrically connected with the upper electrode film, wherein the dielectric film has a circular grooved formed on an upper surface thereof, and wherein the upper electrode film is formed to have an upper surface thereof to correspond to the upper surface of the dielectric film.

### CROSS-REFERENCE TO RELATED APPLICATIONS

This application claims the benefit of Korean Patent Application No. 10-2014-0077631, filed with the Korean Intellectual Property Office on Jun. 24, 2014, the disclosure of which is incorporated herein by reference in its entirety.

### BACKGROUND

1. Technical Field

The present invention relates to a multi-layered ceramic capacitor and a method of manufacturing the same.

2. Background Art

Multi-layered ceramic capacitors (MLCCs), which are chip-type capacitors laminated with a plurality of dielectric layers having electrodes printed thereon, are widely used in various electronic products. As the mobile communication device and portable electronic device markets are expanded recently, there have been increasing demands for MLCC products that are smaller and have a greater capacity.

The conventional MLCCs have been produced by forming a laminate by laminating a plurality of green sheets coated with an electrode paste and then by forming lateral electrodes on either lateral surfaces. Accordingly, it has been difficult to allow the MLCCs to be smaller and have a greater capacity through such a bulk process.

To address this issue, studies are actively underway for implementing a semiconductor thin film process in the MLCC field. For example, an MLCC manufacturing method has been proposed to thinly laminate highly-dielectric ceramic materials by use of various thin film deposition equipment.

However, since the conventional MLCCs are formed on a limited surface of substrate, the active area for determining the capacitance has to be practically limited.

Accordingly, the number of lamination needs to be increased in order to provide a higher capacitance, inevitably increasing the photolithography and etching process and thus complicating the overall processes.

Moreover, due to restrictions caused by the flat plate structure, it was difficult for the conventional thin film type MLCCs to provide a higher capacitance.

The related art of the present invention is disclosed in Japan Patent Publication No. 2001-181839 (laid open on Jul. 3, 2001).

### SUMMARY

The present invention provides a multi-layered capacitor that can provide a high capacitance and a method of manufacturing the multi-layered capacitor.

Moreover, the present invention provides a multi-layered capacitor that can be made smaller and a method of manufacturing the multi-layered capacitor.

An aspect of the present invention provides a multi-layered capacitor that includes: a laminate structure having a plurality of unit structures laminated therein, the plurality of unit structures each including a substrate, a lower electrode film formed over the substrate, a dielectric film formed over the lower electrode film and an upper electrode film formed over the dielectric film; a first external electrode formed on one surface of the laminate structure and configured to be electrically connected with the lower electrode film; and a second external electrode formed on the other surface of the laminate structure and configured to be electrically connected with the upper electrode film, wherein the dielectric film has a circular grooved formed on an upper surface thereof, and wherein the upper electrode film is formed to have an upper surface thereof to correspond to the upper surface of the dielectric film.

The circular groove may be provided in plurality.

The plurality of circular grooves may be concentric.

The substrate may have a first groove formed on an upper surface thereof, the first groove corresponding to a position of the circular groove.

The lower electrode film may have a second groove formed on an upper surface thereof, the second groove corresponding to a position of the circular groove.

The plurality of unit structures may each further include an insulating layer formed over the upper electrode film.

The laminate structure may include an adhesive layer interposed between the unit structures that are adjacent to each other.

Another aspect of the present invention provides a method of manufacturing a multi-layered capacitor that includes: forming a plurality of unit structures, each including a substrate, a lower electrode film formed over the substrate, a dielectric film formed over the lower electrode film and an upper electrode film formed over the dielectric film; forming a laminate structure by laminating the plurality of unit structures with one another; and forming a first external electrode and a second external electrode on the laminate structure, the first external electrode being formed on one surface of the laminate structure and configured to be electrically connected with the lower electrode film and the second external electrode being formed on the other surface of the laminate structure and configured to be electrically connected with the upper electrode film, wherein the dielectric film has a circular grooved formed on an upper surface thereof, and wherein the upper electrode film is formed to have an upper surface thereof to correspond to the upper surface of the dielectric film.

The circular groove may be provided in plurality.

The plurality of circular grooves may be concentric.

The substrate may have a first groove formed on an upper surface thereof, the first groove corresponding to a position of the circular groove.

The lower electrode film may have a second groove formed on an upper surface thereof, the second groove corresponding to a position of the circular groove.

The forming of the plurality of unit structures may include forming an insulating layer over the upper electrode film.

The forming of the laminate structure may further include forming an adhesive layer interposed between the unit structures that are adjacent to each other.

### BRIEF DESCRIPTION OF THE DRAWINGS

FIG. 1 is a cross-sectional view showing a multi-layered capacitor in accordance with a first embodiment of the present invention.

FIG. 2, FIG. 3, FIG. 4, FIG. 5, FIG. 6 and FIG. 7 illustrate a manufacturing process of a unit structure implemented in the first embodiment of the present invention.

FIG. 8 and FIG. 9 illustrate a process for manufacturing a laminate structure implemented in the first embodiment of the present invention by use of the unit structure manufactured by the manufacturing process shown in FIG. 2, FIG. 3, FIG. 4, FIG. 5, FIG. 6 and FIG. 7.

FIG. 10 is a cross-sectional view showing a multi-layered capacitor in accordance with a second embodiment of the present invention.

FIG. 11 is a cross-sectional view showing a multi-layered capacitor in accordance with a third embodiment of the present invention.

### DETAILED DESCRIPTION

The terms used in the description are intended to describe certain embodiments only, and shall by no means restrict the present invention. Unless clearly used otherwise, expressions in a singular form include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

When one element is described to be “coupled” to another element, it does not refer to a physical, direct contact between these elements only, but it shall also include the possibility of yet another element being interposed between these elements and each of these elements being in contact with said yet another element.

Hereinafter, certain embodiments of a multi-layered ceramic capacitor and a manufacturing method thereof in accordance with the present invention will be described in detail with reference to the accompanying drawings. In describing the present invention with reference to the accompanying drawings, any identical or corresponding elements will be assigned with same reference numerals, and no redundant description thereof will be provided.

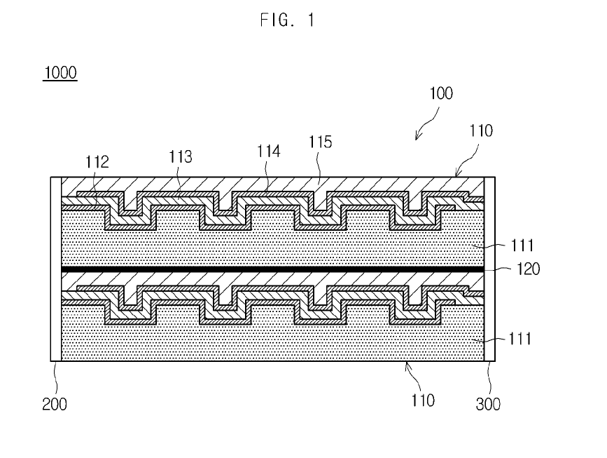

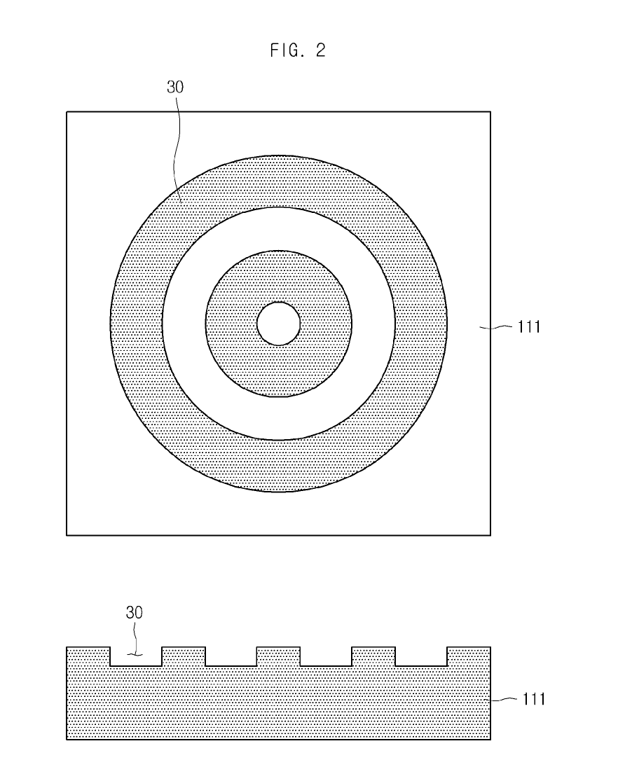

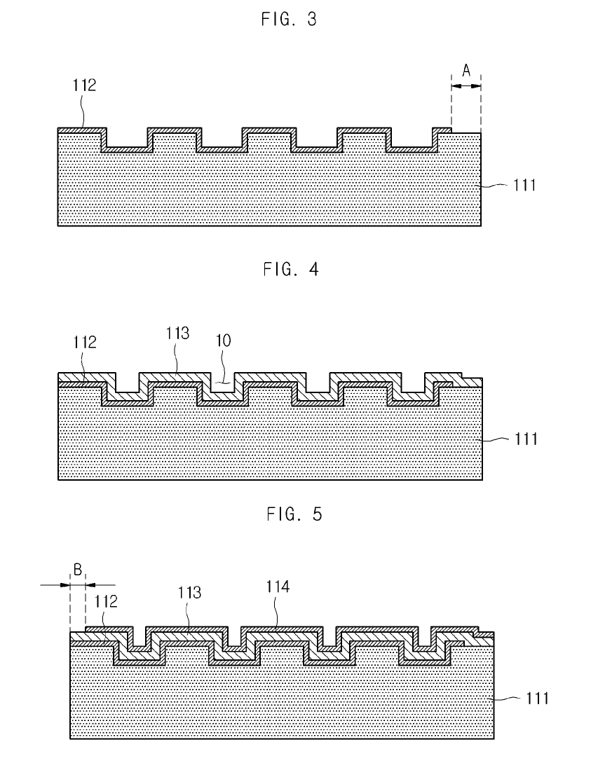

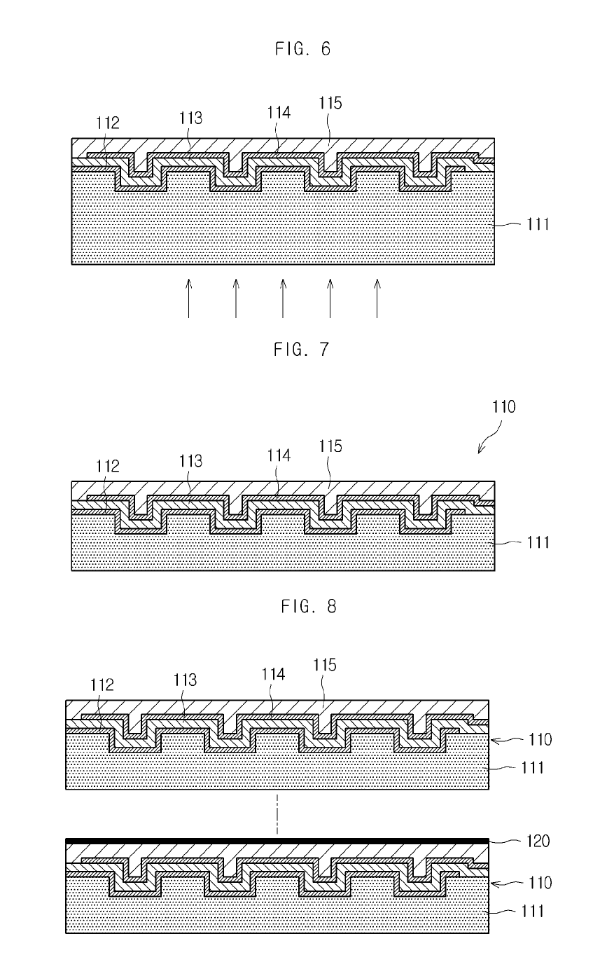

FIG. 1 is a cross-sectional view showing a multi-layered capacitor in accordance with a first embodiment of the present invention. FIG. 2, FIG. 3, FIG. 4, FIG. 5, FIG. 6 and FIG. 7 illustrate a manufacturing process of a unit structure implemented in the first embodiment of the present invention. FIG. 8 and FIG. 9 illustrate a process for manufacturing a laminate structure implemented in the first embodiment of the present invention by use of the unit structure manufactured by the manufacturing process shown in FIG. 2, FIG. 3, FIG. 4, FIG. 5, FIG. 6 and FIG. 7.

As illustrated in FIG. 1 to FIG. 9, a multi-layered capacitor 1000 in accordance with an embodiment of the present invention may include a laminate structure 100 and further include a first external electrode 200 and a second external electrode 300.

As the laminate structure 100 may be formed by having a unit structure 110 laminated multiple times, the unit structure 110 will be described first hereinafter.

The unit structure 110 may include a substrate 111, a lower electrode film 112 formed over the substrate 111, a dielectric film 113 formed over the lower electrode film 112 and having a circular groove 10 formed on an upper surface thereof, and an upper electrode film 114 formed over the dielectric film 113. Moreover, the unit structure 110 may further include an insulating layer 115 formed over the upper electrode film 114.

The lower electrode film 112 and the upper electrode film 114 may be connected with electrodes outside the unit structure 110 to apply electric charge to the dielectric film 113. That is, by being formed above and below the dielectric film 113, respectively, and being supplied with electric charge from outside electrodes, the lower electrode film 112 and the upper electrode film 114 may induce electric charges, having opposite polarities, to an upper portion and a lower portion of the dielectric film 113, respectively. The lower electrode film 112 and the upper electrode film 114 may be made of a conductive material. For example, lower electrode film 112 and the upper electrode film 114 may be made of at least one metal selected from the group consisting of Pt, Ru, Ir, Au, Ni, Mo, W, Al, Ta, Ag and Ti or a conductive oxide or conductive nitride of at least one metal selected from the group consisting of Pt, Ru, Ir, Au, Ni, Mo, W, Al, Ta, Ag and Ti.

Polarization of the dielectric film 113 may be induced by the electric charge applied to the lower electrode film 112 and the upper electrode film 114. The dielectric film 113 may be made of a highly dielectric material, such as TiO₂, ZrO₂, Al₂O₃, Ta₂O₅, Nb₂O₅, HfO₂, SrTiO₃, BaTiO₃, (Ba, Sr)TiO₃, PbTiO₃, SrBi₂Ta₂O₉, (Pb,La)(Zr,Ti)O₃ or Pb(Zr, Ti)O₃, or a combination thereof, and may be added with a dopant.

The circular groove 10 may increase a surface area of the dielectric film 113. That is, since the capacitance of a capacitor may be proportional to the surface area of the dielectric film 113, the circular groove 10 may function to increase the surface area of the dielectric film 113 by as much as the area in which the circular groove 10 is formed, thereby increasing the capacitance of the capacitor.

The circular groove 10 may be formed by having a first groove 30 formed on an upper surface of the substrate 111 at a location corresponding to a position of the circular groove 10. Specifically, the first groove 30 may be first formed circularly on the upper surface of the substrate 111, and then by having the lower electrode film 112 and the dielectric film 113 formed successively along the upper surface of the substrate 111 that contains the first groove 30, the circular groove 10 corresponding to the first groove 30 may be formed on the upper surface of the dielectric film 113.

A longitudinal section of the first groove 30 may have various shapes, such as a hemispherical grain form, a pin form or a cylinder form. Accordingly, the circular groove 10 of the dielectric film 113 may be formed in various shapes corresponding to that of the longitudinal section of the first groove 30.

The first groove 30 may be formed to have a longitudinal aspect ratio of 1 or greater and 50 or smaller. By allowing the longitudinal aspect ratio to be 1 or greater, the surface area of the dielectric film 113 may be effectively increased. If the longitudinal aspect ratio were greater than 50, the lower electrode film 112 and the dielectric film 113 might not be formed along the longitudinal section of the first groove 30 due to limited coverage.

The circular groove 10 may be provided in plurality. That is, by having the first groove 30 formed in plurality on the upper surface of the substrate 111 and having the dielectric film 113 formed over the plurality of first grooves 30, the circular groove 10 may be formed in plurality. By having the circular groove 10 formed in plurality, the surface area of the dielectric film 113 may be increased compared to when the circular groove 10 is formed in singularity, making it possible to increase the capacitance.

The plurality of circular grooves 10 may be concentric. That is, by having the plurality of first grooves 30 formed concentrically on the upper surface of the substrate 111, the plurality of circular grooves 10 of the dielectric film 113 formed on the substrate 111 may be formed concentrically as well.

The insulating layer 115 may be formed over the upper electrode film 114 to protect the upper electrode film 114 positioned underneath the insulating layer 115. Like a common protective layer, the insulating layer 115 may be made of an oxide, such as SiO₂, or a nitride, such as Si₃N₄, and the material for the insulating layer 115 may be selected by considering relative thermal and/or mechanical characteristics of the upper electrode film 114, an adhesive layer 120, which will be described later, and the substrate 111.

As illustrated in FIG. 8 and FIG. 9, the laminate structure 100 may be formed by laminating the above-described unit structure 110 multiple times.

The laminate structure 100 may further include the adhesive layer 120 that is interposed between the unit structure 110 and an adjacent unit structure 110. That is, by forming the adhesive layer 120 between the unit structures 110 being laminated with each other, pressing the unit structures 110 and hardening the adhesive layer 120, the laminate structure 100 may be formed more readily.

As shown in FIG. 8, the adhesive layer 120 may be formed on an upper surface of the unit structure 110 that is positioned at a lower part of the laminate structure 100, but it is also possible that the adhesive layer 120 is formed on a lower surface of the unit structure 110 that is positioned at an upper part of the laminate structure 100.

The first external electrode 200 may be formed on one surface of the laminate structure 100 to electrically connect the lower electrode film 112 of the unit structure 110 that is arranged thereabove with the lower electrode film 112 of the unit structure 110 that is arranged therebelow. The second external electrode 300 may be formed on the other surface of the laminate structure 100 to electrically connect the upper electrode film 114 of the unit structure 110 that is arranged thereabove with the upper electrode film 114 of the unit structure 110 that is arranged therebelow.

That is, as the laminate structure 100 is formed by having a plurality of unit structures 110, each including the lower electrode film 112, laminated with one another, the first external electrode 200 is formed on the one surface of the laminate structure 100, and every lower electrode film 112 is connected with the first external electrode 200, thereby allowing a plurality of lower electrode films 112 to be electrically connected with one another. In a similar fashion, the second external electrode 300 may electrically connect a plurality of upper electrode films 114 with one another.

In such a case, by forming the lower electrode film 112 of the unit structure 110 to be extended to one side of the unit structure 110 and forming the upper electrode film 114 of the unit structure 110 to be extended to the other side of the unit structure 110, the lower electrode film 112 may be connected to the first external electrode 200, and the upper electrode film 114 may be connected to the second external electrode 300.

The first external electrode 200 and the second external electrode 300 may be made of a conductive material. For example, a known material, such as Au, Pd, Ni, Ag or an alloy thereof, may be used to form the first external electrode 200 and the second external electrode 300.

Accordingly, the multi-layered capacitor 1000 in accordance with the first embodiment of the present invention may have an increased surface area of the dielectric film 113, thereby increasing the capacitance thereof. Moreover, a plurality of unit structures 110 may be laminated and electrically connected with one another, and thus the capacitance of the multi-layered capacitor 1000 in accordance with the first embodiment of the present invention may be increased by as much as the number of laminations of the unit structure 110.

Hereinafter, multi-layered capacitors 2000, 3000 in accordance with a second embodiment and a third embodiment, respectively, will be described.

Elements and their associated effects disclosed in the multi-layered capacitors 2000, 3000 in accordance with the second and third embodiments have been already described with reference to the multi-layered capacitor 1000 in accordance with the first embodiment of the present invention, and thus the detailed description thereof will not be redundantly provided herein.

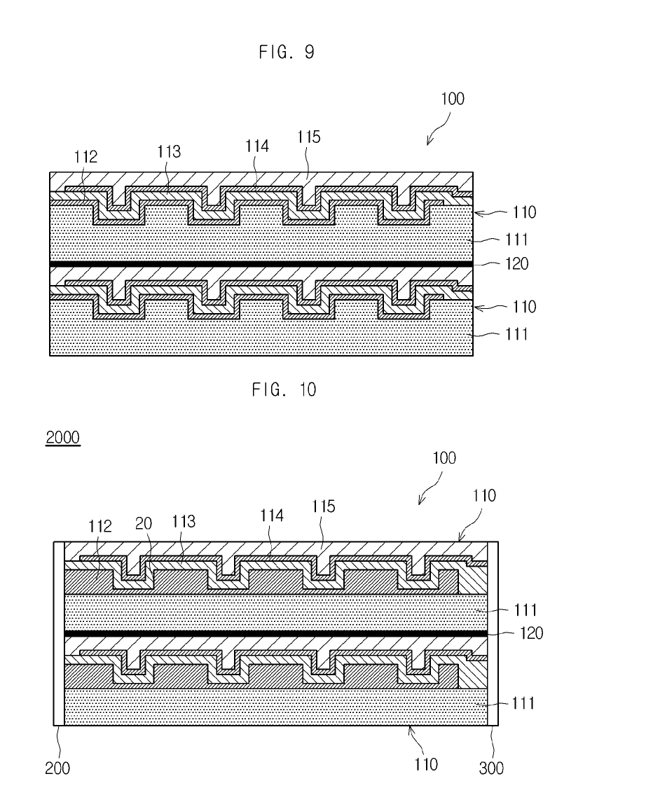

FIG. 10 is a cross-sectional view showing the multi-layered capacitor 2000 in accordance with the second embodiment of the present invention.

As shown in FIG. 10, the multi-layered capacitor 2000 in accordance with the second embodiment of the present invention may have a second groove 20 formed on an upper surface of a lower electrode film 112 at a location corresponding to a position of a circular groove 10. Unlike the first embodiment of the present invention, in which the circular groove 10 is formed on the upper surface of the dielectric film 113 by forming the first groove 30 on the substrate 111, the lower electrode film 112 may be formed on an upper surface of a flat substrate 111, and the second groove 20 may be formed on the upper surface of the lower electrode film 112. By having a dielectric film 113 formed on the upper surface of the lower electrode film 112 that includes the second groove 20, an upper surface of the dielectric film 113 may have the circular groove 10.

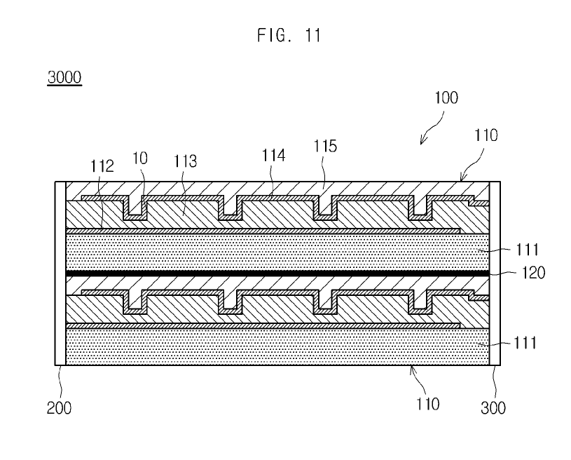

FIG. 11 is a cross-sectional view showing the multi-layered capacitor 3000 in accordance with the third embodiment of the present invention.

As shown in FIG. 11, the multi-layered capacitor 3000 in accordance with the third embodiment of the present invention may not form the first groove 30 or the second groove 20 on the substrate 111 or on the lower electrode film 112, unlike the first embodiment and the second embodiment of the present invention. That is, a circular groove 10 may be formed on an upper surface of a dielectric film 113 by forming a flat substrate 111 and a flat lower electrode film 112 and processing the circular groove 10 directly on the upper surface of the dielectric film 113 that is formed on the lower electrode film 112.

As illustrated in FIG. 10 and FIG. 11, the embodiments of the present invention may vary the layer where the circular groove is processed, thereby providing a convenience in the manufacturing process.

Embodiments of the present invention provide a method of manufacturing a multi-layered capacitor.

Hereinafter, a method of manufacturing a multi-layered capacitor 1000 in accordance with a first embodiment of the present invention will be described.

The method of manufacturing a multi-layered capacitor 1000 in accordance with the first embodiment of the present invention includes: forming a first unit structure 110; forming a second unit structure 110; and forming a laminate structure 100 by laminating the second unit structure 110 over the first unit structure 110. Here, the first unit structure 110 and the second unit structure 110 may be simultaneously formed.

In an embodiment of the present invention, the forming of the first unit structure 110 may include: forming a first substrate 111 and a first lower electrode film 112 on the first substrate 111; forming a first dielectric film 113 over the first lower electrode film 112 and forming a first circular groove 10 on an upper surface of the first dielectric film 113; and forming a first upper electrode film 114 over the first dielectric film 113. The forming of the first upper electrode film 114 may be followed by forming a first insulating layer 115 on the first upper electrode film 114. The forming of the first lower electrode film 112 on the first substrate 111 may include: forming a first groove 30 on an upper surface of the first substrate 111 at a position corresponding to the first circular groove 10; and forming the first lower electrode film 112 on the upper surface of the first substrate 111 including the first groove 30.

As the first unit structure 110 and the second unit structure 110 may be formed using a same method, the following description will be provided for the case of forming the first unit structure 110.

Referring to FIG. 2 to FIG. 9, the circular, first groove 30 is formed first on the upper surface of the substrate 111. The first groove 30 may be formed through a known method, including wet etching, dry etching, etc. Here, the first groove 30 may be formed in plural units that are concentric. Moreover, the first groove 30 may be formed to have various shapes of longitudinal section, as described earlier, by use of anisotropic etching or isotropic etching.

Then, the lower electrode film 112 is formed throughout the upper surface of the substrate 111 containing the first groove 30. Here, as shown in FIG. 3, the lower electrode film 112 may be extended to one end of the substrate 111. As a result, the lower electrode film 112 may be extended to one end of a unit structure 110, which is formed by a process to follow, and may be electrically connected with a first external electrode 200, which is formed at the one end of the unit structure 110.

The lower electrode film 112 is not extended to the other end of the substrate 111. That is, the lower electrode film 112 may be formed by forming a conductive film on the upper surface of the substrate 111 and then etching an area marked “A” of the conductive film. Alternatively, the lower electrode film 112 may be formed by coating a photo resist in the area marked “A” of the substrate 111, forming the conductive film on the upper surface of the substrate 111 including the area marked “A” and then removing the photo resist.

Next, a dielectric film 113 is formed on an upper surface of the lower electrode film 112. By forming the dielectric film 113 after forming the first groove 30 and the lower electrode film 112, a circular groove 10 corresponding to the first groove 30 formed on the substrate 111 may be formed on an upper surface of the dielectric film 113.

Afterwards, an upper electrode film 114 is formed on the upper surface of the dielectric film 113. Here, as shown in FIG. 5, the upper electrode film 114 may not be extended to one end of the dielectric film 113 while being extended to the other end of the dielectric film 113. As a result, the upper electrode film 114 may be extended to the other end of the unit structure 110, which is formed by a process to follow, and may be electrically connected with a second external electrode 300, which is formed at the other end of the unit structure 110.

The upper electrode film 114 is not extended to the one end of the dielectric film 113. That is, the upper electrode film 114 may be formed by forming a conductive film on the upper surface of the dielectric film 113 and then etching an area marked “B” of the conductive film. Alternatively, the upper electrode film 114 may be formed by coating a photo resist in the area marked “B” of the dielectric film 113, forming the conductive film on the upper surface of the dielectric film 113 including the area marked “A” and then removing the photo resist.

The upper electrode film 114, the lower electrode film 112 and the dielectric film 113 may be formed by use of various methods, such as chemical vapor deposition, atomic layer deposition, etc.

Then, an insulating layer 115 may be formed over the upper electrode film 114 in such a way that an upper surface of the unit structure 110 becomes flat. If necessary, in order to make a final product even smaller, the method may additionally include grinding a lower surface of the substrate 111 so as to reduce a thickness of the unit structure 110. Here, the lower surface of the substrate 111 may be ground by use of a CMP process.

The first unit structure 110 and the second unit structure 110, which are formed as described above, are aligned and laminated with each other to form the laminate structure 100. Here, the laminate structure 100 may be formed by applying heat and pressure to the first unit structure 110 and the second unit structure 110. Moreover, the laminate structure 100 may be formed by forming an adhesive layer 120 in between the first unit structure 110 and the second unit structure 110, pressing the first unit structure 110 and the second unit structure 110 and hardening the adhesive layer 120.

Although FIG. 8 and FIG. 9 show that the laminate structure 110 is constituted with two unit structures 110, this is depicted for illustrative purposes only, and it is possible that the number of laminations may be increased by considering the required capacitance and device size. Moreover, although it is illustrated in FIG. 8 that the adhesive layer 120 is formed above the first unit structure 110 that is positioned at a lower portion of the laminate structure 100, this is depicted for illustrative purposes only, and it is also possible that the adhesive layer 120 is formed below the second unit structure 110 that is positioned at an upper portion of the laminate structure 100.

Afterwards, the first external electrode 200 may be formed on one surface of the laminate structure 100, and the second external electrode 300 may be formed on the other surface of the laminate structure 100. By doing this, the unit structures 110 positioned above and below the laminate structure 100 may be electrically connected with each other. Specifically, a plurality of lower electrode films 112 are connected with the first external electrode 200, and a plurality of upper electrode films 114 are connected with the second external electrode 300.

Hereinafter, methods of manufacturing a multi-layered capacitor 2000, 3000 in accordance with a second embodiment and a third embodiment, respectively, of the present invention will be described. Since most of the elements and their effects associated with the methods of manufacturing a multi-layered capacitor 2000, 3000 in accordance with these embodiments have been already described above with reference to the method of manufacturing a multi-layered capacitor 1000 in accordance with the first embodiment of the present invention, any redundant description will not be provided herein.

In the method of manufacturing a multi-layered capacitor 2000 in accordance with the second embodiment of the present invention, forming a first lower electrode film 112 on an upper surface of a first substrate 111 may include forming a second groove 20 on an upper surface of the first lower electrode film 112 at a position corresponding to a first groove 10. In other words, the lower electrode film 112 may be formed on the flat surface of the substrate 111, and then the second groove 20 may be formed on the upper surface of the lower electrode film 112. By forming a dielectric film 113 on the upper surface of the lower electrode film 112 including the second groove 20, a circular groove 10 may be formed on an upper surface of the dielectric film 113.

In the method of manufacturing a multi-layered capacitor 3000 in accordance with the third embodiment of the present invention, a lower electrode film 112 is formed over a substrate 111 having a flat surface, and a dielectric film 113 is formed over the lower electrode film 112 having a flat surface. Then, a circular groove 10 may be formed on an upper surface of the dielectric film 113. The circular groove 10 may be formed through a known method, such as etching, as described above.

Although certain embodiments of the present invention have been described hitherto, it shall be appreciated that the present invention can be variously modified and permuted by those of ordinary skill in the art to which the present invention pertains by supplementing, modifying, deleting and/or adding an element without departing from the technical ideas of the present invention, which shall be defined by the claims appended below. It shall be also appreciated that such modification and/or permutation are also included in the claimed scope of the present invention.

What is claimed is:

1. A multi-layered capacitor comprising:
a laminate structure having a plurality of unit structures laminated therein, the plurality of unit structures each comprising a substrate, a lower electrode film formed over the substrate, a dielectric film formed over the lower electrode film and an upper electrode film formed over the dielectric film;
a first external electrode formed on one surface of the laminate structure and configured to be electrically connected with the lower electrode film; and
a second external electrode formed on the other surface of the laminate structure and configured to be electrically connected with the upper electrode film,
wherein the dielectric film has a circular groove formed on an upper surface thereof, and
wherein the upper electrode film is formed to have an upper surface thereof to correspond to the upper surface of the dielectric film.

2. The multi-layered capacitor of claim 1, wherein the circular groove is provided in plurality.

3. The multi-layered capacitor of claim 2, wherein the plurality of circular grooves are concentric.

4. The multi-layered capacitor of claim 1, wherein the substrate has a first groove formed on an upper surface thereof, the first groove corresponding to a position of the circular groove.

5. The multi-layered capacitor of claim 1, wherein the lower electrode film has a second groove formed on an upper surface thereof, the second groove corresponding to a position of the circular groove.

6. The multi-layered capacitor of claim 1, wherein the plurality of unit structures each further comprise an insulating layer formed over the upper electrode film.

7. The multi-layered capacitor of claim 1, wherein the laminate structure comprises an adhesive layer interposed between the unit structures that are adjacent to each other.

8. A method of manufacturing a multi-layered capacitor, the method comprising:
forming a plurality of unit structures, each comprising a substrate, a lower electrode film formed over the substrate, a dielectric film formed over the lower electrode film and an upper electrode film formed over the dielectric film;
forming a laminate structure by laminating the plurality of unit structures with one another; and
forming a first external electrode and a second external electrode on the laminate structure, the first external electrode being formed on one surface of the laminate structure and configured to be electrically connected with the lower electrode film and the second external electrode being formed on the other surface of the laminate structure and configured to be electrically connected with the upper electrode film,
wherein the dielectric film has a circular grooved formed on an upper surface thereof, and
wherein the upper electrode film is formed to have an upper surface thereof to correspond to the upper surface of the dielectric film.

9. The method of claim 8, wherein the circular groove is provided in plurality.

10. The method of claim 9, wherein the plurality of circular grooves are concentric.

11. The method of claim 8, wherein the substrate has a first groove formed on an upper surface thereof, the first groove corresponding to a position of the circular groove.

12. The method of claim 8, wherein the lower electrode film has a second groove formed on an upper surface thereof, the second groove corresponding to a position of the circular groove.

13. The method of claim 8, the forming of the plurality of unit structures comprises forming an insulating layer over the upper electrode film.

14. The method of claim 8, wherein the forming of the laminate structure comprises forming an adhesive layer interposed between the unit structures that are adjacent to each other.
